(19) United States
(12) Patent Application Publication
(10) Pub. No.: US 2007/0272623 A1
(43) Pub. Date: Nov. 29, 2007

(54) Multi-zone ground water and soil treatment

(76) Inventor: William B. Kerfoot, Falmouth, MA (US)

Correspondence Address: FISH & RICHARDSON PC, P.O. BOX 1022, MINNEAPOLIS, MN, 55440-1022, US

(21) Appl. No.: 11/440,579

(22) Filed: May 25, 2006

(51) Int. Cl. C02F 1/72

(52) U.S. Cl. 210/759

(57) ABSTRACT

Apparatus and method for introducing a first fluid of a first oxidative/reductive potential type into a first zone of a site and introducing a second fluid of a second, different oxidative/reductive potential type into a second zone of the site, with the second zone and the first zone adjacent each other to efficiently remove contaminants from groundwater and surrounding soils.

### BACKGROUND

This invention relates generally to water remediation systems and techniques.

There is a well-recognized need for removal of subsurface contaminants that exist in aquifers and surrounding soils. Such contaminants can include various man-made volatile hydrocarbons. However, other types of man-made contaminants can be present in soil and groundwater. Contaminants from run-off of agricultural land include nitrogen containing compounds are often found in subsurface plumes that migrate towards bodies of water such as streams, lakes, etc. Additionally, sewage from septic systems, municipal systems or even animal sewage from farms can be a significant source of nitrogen containing contaminants. For instance, when such sewage decomposes it forms ammonia.

U.S. Pat. No. 4,465,594, by Laak (1984) treats domestic sewage by aerobic/anaerobic segregation and recombination. In Laak, the domestic waste stream was segregated into anaerobic grey water (laundry wastewater) and then later combined with aerated black water (toilet wastewater) under conditions of maintaining a slight acidic condition (pH=4). Laak relied on the grey water as a source of carbon for the de-nitrification filtration in the anaerobic process of de-nitrification where the nitrates are reduced to inert nitrogen gas in a reducing liquid waste of approximately 240 millivolts (mv) provided through the decomposition of the nitrates in the absence of oxygen. De-nitrification is commonly represented as:

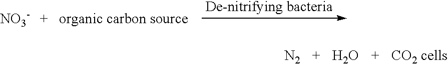

Bacteria use nitrate as an electron acceptor in anoxic environments. The temperature and pH should be above 10° C. and pH 5.5, respectively (Laak, 1986, Wastewater Engineering Design for Unsewered Areas).

### SUMMARY

According to an aspect of the present invention, a method includes introducing a first fluid of a first oxidative/reductive potential type into a first zone of a site and introducing a second fluid of a second, different oxidative/reductive potential type into a second zone of the site, with the second zone and the first zone adjacent each other.

The following are embodiments within the scope of the invention.

Introducing uses an oxidant as the first fluid. The first fluid is introduced as air/ozone gas stream. The first fluid is introduced as air/ozone gas stream delivered with hydrogen peroxide, and/or a hydro-peroxide, which is a substantial byproduct of a reaction of a contaminant present in the aquifer or soil formation with the ozone. The predominate groundwater flow in the site is from the first zone into the second zone. The hydro-peroxide or hydrogen peroxide is delivered as a surface layer over microbubbles including air/ozone gas stream. The hydro-peroxide or hydrogen peroxide is delivered with a first diffuser that is disposed above a second diffuser that delivers the air/ozone gas stream.

Introducing the second fluid includes introducing a reducing agent into a soil/water formation in the second zone. The reducing agent is selected from the group consisting of hydrogen sulfide, sodium dithionate, sodium thiosulfate, ferrous sulfate, and ferrous sulfite. The microporous diffuser includes promoters or nutrients such as catalyst agents including iron containing compounds such as iron silicates or palladium containing compounds such as paladized carbon and platinum. The introducing action occurs using microporous diffusers having a pore size in the range of about 0.1 to 200 microns.

The method includes introducing a third fluid of a third, different oxidative/reductive potential into a third zone of the site, with the third zone being adjacent the second zone. Introducing the third fluid uses an oxidant as the third fluid. The third fluid is a diluted quantity of the first fluid. The third fluid is introduced as air/ozone gas stream.

According to an additional aspect of the present invention, an apparatus arrangement includes a first set of sparging apparatus, feeding a first fluid to a soil formation, the first fluid providing initial treatment of a contaminant plume in the soil formation, a second set of sparging apparatus, disposed adjacent to the first set of apparatus, downstream from determined groundwater flow, and feeding a second fluid to the soil formation, the second fluid providing subsequent treatment of the plume in the soil formation, as the plume emerges from the first set of sparging apparatus.

The following are embodiments within the scope of the invention.

The first set of sparging apparatus introduces air and ozone as a gas. The second set of sparging apparatus introduces a reducing gas as microbubbles to decompose compounds. The second set introduces a reducing gas as hydrogen sulfide diluted with nitrogen or helium The apparatus further includes a third set of sparging apparatus, feeding a third fluid into the soil formation, the third fluid to restore the plume from the second set of sparging apparatus to an ORP that is acceptable for the site. The first set of sparging apparatus introduces air and ozone as a gas and a hydro-peroxide or hydrogen peroxide as a liquid into the soil formation. The oxidant is oxygen and ozone and the reducing agent is selected from the group consisting of hydrogen sulfide, sodium dithionate, sodium thiosulfate, ferrous sulfate, and ferrous sulfite.

The sparging apparatuses include at least one microporous diffuser having a pore size in the range of about 0.1 to 200 microns. The diffuser is a microporous diffuser that has a porosity characteristic that permits bubbles of 1-200 microns diameter to be released into the surrounding soil formation. At least one of the first set and second set of sparging apparatus includes a well having a casing with an inlet screen and outlet screen to promote a recirculation of water into the casing and through surrounding ground area, with the diffuser disposed in the well. At least one of the first set and second set of sparging apparatus includes a microporous diffuser that is driven into the soil formation. At least one of the first set and second set of sparging apparatus includes a borehole having a casing with a microporous diffuser disposed in the borehole.

The apparatus further includes a third set of sparging apparatus, disposed adjacent to the second set of apparatus, downstream from determined groundwater flow, feeding a third fluid to the soil formation, the third fluid providing subsequent treatment of the plume in the soil formation, as the plume emerges from the second set of sparging apparatus.

According to an additional aspect of the present invention, a method includes introducing a first oxidizing fluid of a first oxidative potential into a first zone of a site, introducing a reducing fluid of a reduction potential into a second zone of the site and introducing a second oxidizing fluid of a second oxidative potential into a third zone of the site, with the first zone adjacent the second zone and the second zone adjacent the third zone.

The following are embodiments within the scope of the invention.

The first oxidizing and the second oxidizing fluids are the same and both are selected from the group consisting of ozone and oxygen. The first oxidizing and the second oxidizing fluids are different. The oxidizing fluids are introduced as air/ozone gas stream. The first oxidizing fluid is introduced as air/ozone gas stream delivered with hydrogen peroxide, and/or a hydro-peroxide, which is a substantial byproduct of a reaction of a contaminant present in the aquifer or soil formation with the ozone. The reducing fluid is selected from the group consisting of hydrogen sulfide, sodium dithionate, sodium thiosulfate, ferrous sulfate, ferrous sulfite, methanol, ethanol, and lactate. The second oxidizing fluid is a diluted quantity of the first second oxidizing fluid. The hydro-peroxide or hydrogen peroxide is delivered as a surface layer over microbubbles including air/ozone gas stream. The hydro-peroxide or hydrogen peroxide is delivered with a first diffuser that is disposed above a second diffuser that delivers the air/ozone gas stream.

One or more aspects of the invention may provide one or more of the following advantages.

The ability to oxidize a contaminant followed by reduction has the capacity to deal with many types of plumes. Ammonia in flowing groundwater can be oxidized to nitrate, as in Laak. However, an additional advantage of microbubble oxidation is that the ammonia can pass through stages of gaseous ammonia, NO₂, and NO where it can be removed as a gaseous product. For example, 50% or more of the nitrogen containing by products of ammonia may be removed in this manner. When the complete oxidation stage is reached, nitrogen exists as nitrate. At this stage, the ORP is normally above 100 mv. Certain oxidant gases such as ozone can accomplish this reaction in saturated soils without bacterial action, although bacteria may participate with low ozone concentrations (less than 200 ppm).

The invention may allow physical separation of sequential treatments to oxidize (raise ORP), reduce (lower ORP), and re-oxidize (raise ORP) back to more natural conditions. As groundwater flows through the periodically pulsed zone, reactions occur. The treatment regions can be maintained with less oxidizer or reducer input once an ORP level is achieved. For example, it may take 20 kg of ozone over two weeks to raise the saturated soil ORP to +400 mv, but only 2 kg per week to maintain a 10 ft.×100 ft. treatment zone. Trying to sequentially do oxidation followed by reduction within the same area would require over two times the mass contribution.

The high efficiency at which microbubbles exchange gases, both for extraction of waste gases, like CO₂ or N₂, or to dissolve gases like ozone (oxidative) or H₂S (reductive) allows for a high efficiency over a narrower cross-sectional thickness. The mass reduction rate sets the width of the treatment region for time-of-travel to provide a desirable exit concentration of contaminants, compared to the entering concentration of contaminants.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a diagram of an arrangement of wells to provide treatment zones.

FIG. 2 is a cross-section through a portion of FIG. 1.

FIG. 3 is a process flow chart.

### DETAILED DESCRIPTION

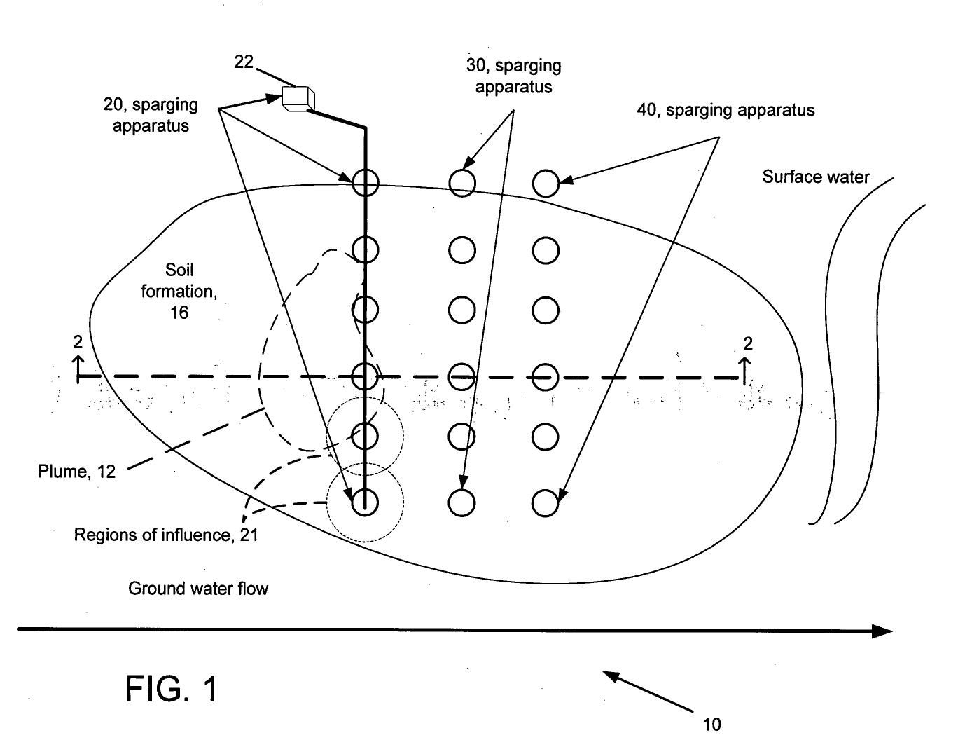

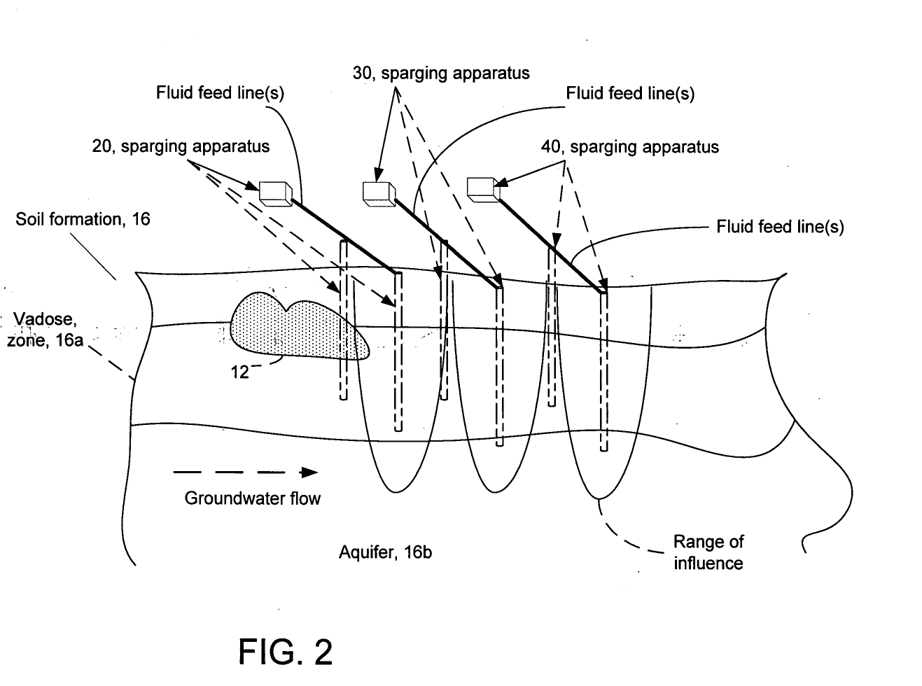

Referring to FIGS. 1 and 2, an example for a treatment arrangement 10 to treat contaminants contained in a plume 12 migrating across a site includes a first set of sparging apparatus 20 to intercept the plume 12. The first set of sparging apparatus 20 is disposed through a soil formation 16, e.g., a vadose zone 16a and here an underlying aquifer 16b. The first set of sparging apparatus 20 is shown as a single row of sparging apparatus 20 in a line, but could be a block of such apparatus 20, e.g., more than one row or other arrangements and patterns. The arrangement 10 includes a second set of sparging apparatus 30, also arranged in a row. The second set of sparging apparatus 30 is spaced from the first set by a distance corresponding to the range of influence of the apparatus 20 and 30. In this arrangement, the sparging apparatus 20, 30, 40 are disposed through the soil formation 16, e.g., a vadose zone 16a and the underlying aquifer. Other vertical arrangements of the sparging apparatus are possible. The arrangement also includes a third set of sparging apparatus 40, also arranged in a row and spaced from the second set by a distance corresponding to the range of influence of the apparatus 30 and 40. The third set 40 being disposed, e.g., through a vadose zone 16a and the underlying aquifer.

Various arrangements of the first, second and third sets of sparging apparatus can be used. For instance, as shown in FIGS. 1 and 2, the first set of sparging apparatus 20 are disposed within a currently estimated location of a contaminant plume 12 and the second and third sets are located outside of the plume 12. FIGS. 1 and 2, show an initial positioning of the system 10. However, over time, the plume 12 migrates towards the first set of sparging apparatus 20 and treatment occurs. When the plume 12 is exhausted, the first set 20 is turned off. Alternatively, the first set 20 can be located just outside of the plume 12 and the plume 12 can migrate towards the first set 20. In another implementation, the second and third sets 30, 40 could be located just inside of the plume along with the first set 20. Other arrangements and configurations are possible.

The arrangement 10 delivers a first fluid to the first set of sparging apparatus 20, a second different fluid to the second set of sparging apparatus 30 and a third different fluid to the third second set of sparging apparatus 40. In some embodiments, the sparging apparatus 20, 30, 40 includes a casing (not shown) positioned through a borehole disposed through the soil formation 16. In the casing, a microporous diffuser or other diffuser portion of the sparging apparatus is disposed to deliver fluids to the formation. In general, the sparging apparatus includes a control element, pumps, and/or compressors, sources of fluids, piping, the diffuser and so forth. An example of a suitable sparging apparatus is C-Sparger® available from Kerfoot Technologies, Inc. Mashpee Mass. Typically, a sparging apparatus can deliver fluids to a plurality of diffusers. Thus, as depicted in FIG. 2, a feed line is used for delivery of fluids to plural diffusers for each of the sparging apparatus 20, 30 and 40.

Preferably, the fluids are delivered, via microbubbles. Other embodiments include injectable microporous diffusers 20a, 30a, 40a, such as can be obtained from Kerfoot Technologies, Inc. Mashpee Mass. Such injectable microporous diffusers are driven directly into the soil formation. In other embodiments, the microporous diffusers 20a, 30a, 40a are laminate microporous diffusers such as can be obtained from Kerfoot Technologies, Inc. Mashpee Mass.

The arrangement of the sparging apparatus 20, 30 and 40 provides three different zones of treatment. The arrangement 10 can be adapted for treatment of several different types of contaminants such as those that need multi-zone in-stitu processing. An example of such a contaminant is a compound containing nitrogen, e.g., ammonia (NH₄OH). Ammonia is a common by-product caused by run-off from farms especially where there is decaying organic fecal type matter, such as in cow and pig farming.

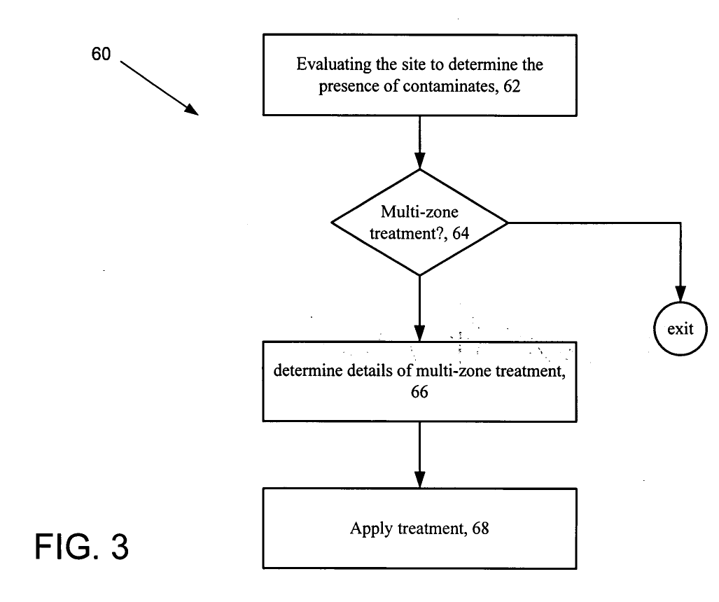

Referring to FIG. 3, a generalized process flow 60 is shown. The process 60 includes evaluating 62 the site to determine the presence of subsurface deposits or plumes of contaminates. The process 60 involves determining 64 if the contaminates present are of a type that requires multi-zone processing. If multi-zone processing is called for, the details of the multi-zone processing are determined 66. The process 60 applies 68 the appropriate multi-zone treatment to the subsurface deposits or plumes.

In an ammonia treatment example, the evaluation 62 of the site yields the presence of ammonia. Having identified the presence of ammonia, which can be treated according to the multi-zone treatment 64, in which the following multi-zone treatment is selected 66.

With ammonia, the three different zones of treatment are used to treat and remove the ammonia and render resulting groundwater flow beyond the third treatment zone acceptable, e.g., prior to reaching a body of water, as depicted in FIG. 1. In a first zone of treatment provided by the first set of sparging apparatus 20, the first fluid delivered to the sparging apparatus 20 is a oxidation/reduction type, e.g., that is a relatively strong oxidant such as ozone and or oxygen, e.g., to an Oxidation Reduction Potential (ORP) of e.g., 400 mv. The second different fluid delivered to the second set of sparging apparatus 30 is the opposite oxidation/reduction type, e.g., a relatively strong reducing agent that lowers the ORP to e.g., −100 mv. The reducing agent here is hydrogen sulfide (H₂S). Other reducing materials include sodium dithionate, sodium thiosulfate, ferrous sulfate, and ferrous sulfite. The reducing agent can also be methanol, ethanol, or lactate, either as a vapor or liquid coating. The reducing agents can be diluted with gases such as nitrogen and helium. The third fluid delivered to the third second set of sparging apparatus 40 is an oxidant, e.g., O₂/O₃ in more diluted proportions than used in the first set of sparging apparatus 20 to restore the treated groundwater to its original ORP.

The concentrations of the first, second and third fluids are determined according to the specific site conditions, e.g., taking into consideration soil ORP, ph, porosity, as well as types and concentrations of contaminants. Illustrative ranges for the first fluid, e.g., oxygen and/or ozone with air is oxygen 20 to 99%; ozone 0.01 to 10%. Illustrative ranges for the second fluid, e.g., hydrogen sulfide with nitrogen is hydrogen sulfide 0.1 to 10%; nitrogen 50 to 99%. Illustrative ranges for the third fluid, e.g., oxygen and/or ozone with air is oxygen/air 20 to 30% O2; ozone, 0.005 to 0.1%. Alternatives for the second fluid could be methanol or ethanol vapor with nitrogen to promote reduced conditions.

With this approach, the plume passes trough three zones. The first zone being highly oxidative, e.g., using O₂ and O₃, oxidizes the ammonia converting the ammonia to, e.g., nitrates (NO₃⁺) according to the reactions:

pH(7-10) 2NH₄OH+3O₃→2HNO₃+3HOH+O₂ Reaction 1

NH₄OH+2O₂→HNO₃+2HOH Reaction 2

According to Henry's law the contaminants, e.g., ammonia is driven into the microbubbles where the oxygen/ozone entrapped in the microbubbles comes in contact with the ammonia and produces the nitrates according to reaction 1 and 2 above. An oxidative-reduction potential of 200-300 mv is commonly obtained.

The plume in the ground water passes from the first zone into the second zone where the nitrates in the plume in the ground water are reduced by application of the strong reducing agent, e.g., hydrogen sulfide, according to Reaction 3:

pH(5-6) NH₃(Ag)+2O₃→HNO₃+HOH+O₂

NH₃(Ag)+2O₂→HNO3+HOH

H₂S+2NHO₃→N₂+SO₂+4OH⁻ Reaction 3

The H₂S present in the microbubbles redacts with the nitrates in the bubble vicinity. The reaction in this treatment zone yields nitrogen gas, which can remain in the soil and is eventually out-gassed, and which is also “bubbled off” through application of the microbubbles that are generated in the second zone. Here, sulfate-reducing conditions are often reached in the −50 to −100 mv range. In accordance with Henry's Law, evolved nitrogen gas is driven into the microbubbles, as these microbubbles travel though the formation. This results in nitrogen being efficiently captured by the microbubbles and carried off into an optional vapor extraction well or alternatively into the air.

The third zone being mildly oxidative readjusts the ground water with oxygen, which is now highly reductive back to a suitable ORP potential (e.g., 50-100 mv) for the formation according to the reaction:

SO₂+O₂+2HOH→2H₂SO₄ Reaction 4

as the sulfates rise as cations in the groundwater.

In each of the treatment zones, the decontamination fluids, O₂, O₃, reducing agent and O₂ again are delivered through microporous diffusers such as Spargepoints® which can be obtained from Kerfoot Technologies. Other types of diffusers, such as slotted well screen could be used with possibly lower effectiveness than the disclosed microporous diffusers. With the microporous diffusers, the microporous diffusers produce microbubbles typically, having a diameter in a range of about 0.1 to 200 or so microns generally dependent on soil porosity characteristics. These microbubbles capture contaminants in the soil including the ammonia, promote the reactions described above and carry off harmless nitrogen gas. Details on sparging with microbubbles are disclosed in several of my U.S. Patents such as U.S. Pat. Nos. 5,855,775 and 6,306,296(B1), which are incorporated herein by reference.

Others of my U.S. Patents such as U.S. Pat. Nos. 6,596,161(B2); 6,582,611(B1); and 6,805,798(B2), which are incorporated herein by reference, disclose laminar microporous diffusers, which can be used to deliver multi-coated microbubbles such as microbubbles entrapping air/ozone, and having a hydrogen peroxide or hydro-peroxide coating on the microbubbles. This type of microbubble for oxidation in the first treatment zone provides especially robust treatments for recalcitrant compounds. Hydro-peroxide compounds are substantial byproducts of reactions with the oxidant and the contaminants, such as formic peracid, hydroxymethyl hydroperoxide, 1-hydroxylethyl hydroperoxide, and chloroformic peracid or their derivatives. Other oxidants can include hydrogen peroxide, sodium persulfate, sodium permanganate, and potassium permanganate.

Other techniques can be used to deliver multiple fluids, e.g., air-ozone (or other gaseous oxidant) with a liquid, such as use of multiple microporous diffusers in a common sparge well. In this case, one microporous diffuser can be used to deliver air-ozone whereas the other microporous diffuser can be disposed above the microporous diffuser delivering the air-ozone and that other microporous diffuser can deliver a liquid such as hydrogen peroxide or hydro-peroxide.

For other contaminants that require an initial reducing environment e.g., ORP less than 0 mv, the first zone would be reductive and the second zone would be oxidative. In this embodiment, the third zone may be reducing, oxidative or not necessary depending on soil conditions and the nature of the plume after treatment in the second zone.

The overall nitrification reaction is:

NH₄⁺+2O₂→NO₃⁻+H₂O+2H⁺

The reaction requires two moles of oxygen for the oxidation of each mole of NH₄⁺. Although conditions are aerobic in order for nitrification to occur, these processes will continue until concentrations of dissolved oxygen decline to about 0.3 mg/L (Wetzel, 1983, Limnology, Second Edition).

Nitrate reduction and de-nitrification by bacteria is the biochemical reduction of oxidized nitrogen anions (NO₃—N and NO₂—N) with concomitant oxidation of organic matter. The general sequence of the process is (Hutchinson, 1957):

NO₃⁻→NO₂⁻→N₂O→N₂

which results in a significant reduction of combined nitrogen that can be transported from the system by gas migration. The NO₂, N₂O, and N₂ can be transported by gaseous bubbles. The common example of the oxidation of glucose and concomitant reduction of nitrate is:

C₆H₁₂O₆+12NO₃⁻=12NO₂⁻+6CO₂+6H₂O[ΔG′₀=−460 kcal mol⁻¹];

and for the reduction of nitrite to molecular nitrogen:

C₆H₁₂O₆+8NO₂⁻=4N₂+2CO₂+4CO₃^{═}+6H₂O [ΔG′₀=720 kcal mol⁻¹]

Approximately as much free energy results as in the aerobic oxidation of glucose by dissolved O₂ (ΔG′₀−699 kcal mol⁻¹). The de-nitrification reactions occur intensely in anaerobic environments, such as in the hypolimnia portion (e.g., unfrozen lake's cold, lowermost, stagnant layer of oxygen-poor water that is below the thermocline) of eutrophic (e.g., rich in nutrients which cause excessive growth of aquatic plants, e.g., algae with resulting bacteria consume nearly all oxygen) lakes and in anoxic sediments, where oxidizable organic substrates are relatively abundant. A specialized case, of much less general quantitative significance than the heterotrophic de-nitrification discussed above, is de-nitrification of nitrate concurrently with the oxidation of sulfur. The process is accomplished by de-nitrifying sulfur bacteria, particularly Thiobacillus denitrificans that use S° or reduced sulfur compounds such as thiosulfate (Kuznetsov, 1970):

5S+6KNO₃+2HₛO→3N₂+K₂SO₄+4KHSO₄

5Na₂SₛOₛ+8KNO₃+2NaHCO₃→6Na₂SO₄+4K₂SO₄+2CO₂+H₂O+4N₂

### Both processes occur chemosynthetically under dark, anaerobic conditions, and yield relatively small changes in free energy.

Other Examples of contaminants that can-use the Oxidation/Reduction arrangement include

| | |
|---|---|
| Nitrogen | Ammonia → Nitrate → N₂, NO, NO₂ |
| Sulfur | Hydrogen sulfide → Sulfate → SO₂ |
| Carbon/Nitrogen containing | Cyanide → Nitrate + CO₂ → N₂, NO, NO₂ |
| Arsenic | Arsenic → Arsenate → Arsenide (AsH) |
| Chlorines | Chloride → Perchlorate → Chlorine |
| Fluorides | Fluoride → Perfluorate → Fluorine |

A number of embodiments of the invention have been described. Nevertheless, it will be understood that various modifications may be made without departing from the spirit and scope of the invention. For example, for certain types of contaminants it may be desirable to first treat with a strong reducing agent, followed by a strong oxidizing agent and finishing with a second weaker reducing agent to restore groundwater to an acceptable ORP. Accordingly, other embodiments are within the scope of the following claims.

What is claimed is:

1. A method comprises:
introducing a first fluid of a first oxidative/reductive potential into a first zone of a site; and
introducing a second fluid of a second, different oxidative/reductive potential into a second zone of the site, with the second zone and the first zone adjacent each other.

2. The method of claim 1 wherein introducing, uses an oxidant as the first fluid.

3. The method of claim 1 wherein the first fluid is introduced as air/ozone gas stream.

4. The method of claim 1 wherein the first fluid is introduced as air/ozone gas stream delivered with hydrogen peroxide, and/or a hydro-peroxide, which is a substantial byproduct of a reaction of a contaminant present in the aquifer or soil formation with the ozone.

5. The method of claim 1 wherein predominate groundwater flow in the site is from the first zone into the second zone.

6. The method of claim 4 wherein the hydro-peroxide or hydrogen peroxide is delivered as a surface layer over microbubbles including air/ozone gas stream.

7. The method of claim 4 wherein the hydro-peroxide or hydrogen peroxide is delivered with a first diffuser that is disposed above a second diffuser that delivers the air/ozone gas stream.

8. The method of claim 1 wherein introducing the second fluid introduces a reducing agent into a soil/water formation in the second zone.

9. The method of claim 9 wherein the reducing agent is selected from the group consisting of hydrogen sulfide, sodium dithionate, sodium thiosulfate, ferrous sulfate, ferrous sulfite, methanol, ethanol, and lactate.

10. The method of claim 1 wherein the microporous diffuser includes promoters or nutrients such as catalyst agents including iron containing compounds such as iron silicates or palladium containing compounds such as paladized carbon and platinum.

11. The method of claim 1 wherein each introducing action occurs using microporous diffusers having a pore size in the range of about 0.1 to 200 microns.

12. The method of claim 1 further comprising
introducing a third fluid of a third, different oxidative/reductive potential into a third zone of the site, with the third zone being adjacent the second zone.

13. The method of claim 12 wherein introducing the third fluid uses an oxidant as the third fluid.

14. The method of claim 12 wherein the third fluid is a diluted quantity of the first fluid.

15. The method of claim 12 wherein the third fluid is introduced as air/ozone gas stream.

16. An apparatus arrangement comprises:
a first set of sparging apparatus, feeding a first fluid to a soil formation, the first fluid providing initial treatment of a contaminant plume in the soil formation;
a second set of sparging apparatus, disposed adjacent to the first set of apparatus, downstream from determined groundwater flow, feeding a second fluid to the soil formation, the second fluid providing subsequent treatment of the plume in the soil formation, as the plume emerges from the first set of sparging apparatus.

17. The apparatus of claim 16 wherein the first set introduces air and ozone as a gas.

18. The apparatus of claim 16 wherein the second set introduces a reducing gas as microbubbles to decompose compounds.

19. The apparatus of claim 16 wherein the second set introduces a reducing gas as hydrogen sulfide diluted with nitrogen or helium.

20. The apparatus of claim 16, further comprising a third set of sparging apparatus, feeding a third fluid into the soil formation, the third fluid to restore the plume from the second set of sparging apparatus to an ORP that is acceptable for the site.

21. The apparatus of claim 16 wherein the first set introduces air and ozone as a gas and a hydro-peroxide or hydrogen peroxide as a liquid into the soil formation.

22. The apparatus of claim 21 wherein the oxidant is oxygen and ozone and the reducing agent is selected from the group consisting of hydrogen sulfide, sodium dithionate, sodium thiosulfate, ferrous sulfate, and ferrous sulfite.

23. The apparatus of claim 16 wherein each sparging apparatus includes at least one microporous diffuser having a pore size in the range of about 0.1 to 200 microns.

24. The apparatus of claim 23 wherein the diffuser is a microporous diffuser that has a porosity characteristic that permits bubbles of 1-200 microns diameter to be released into the surrounding soil formation.

25. The apparatus of claim 16 wherein at least one of the first set and second set of sparging apparatus comprises:
a well having a casing with an inlet screen and outlet screen to promote a recirculation of water into the casing and through surrounding ground area, with the diffuser disposed in the well.

26. The apparatus of claim 16 wherein at least one of the first set and second set of sparging apparatus comprises:
a microporous diffuser that is driven into the soil formation.

27. The apparatus of claim 16 wherein at least one of the first set and second set of sparging apparatus comprises:
a borehole having a casing with a microporous diffuser disposed in the borehole.

28. The apparatus of claim 16, further comprising:
a third set of sparging apparatus, disposed adjacent to the second set of apparatus, downstream from determined groundwater flow, feeding a third fluid to the soil formation, the third fluid providing subsequent treatment of the plume in the soil formation, as the plume emerges from the second set of sparging apparatus.

29. A method comprises:
introducing a first oxidizing fluid of a first oxidative potential into a first zone of a site;
introducing a reducing fluid of a reduction potential into a second zone of the site; and
introducing a second oxidizing fluid of a second oxidative potential into a third zone of the site, with the first zone adjacent the second zone and the second zone adjacent the third zone.

30. The method of claim 29 wherein the first oxidizing and the second oxidizing fluids are the same and both are selected from the group consisting of ozone and oxygen.

31. The method of claim 29 wherein the first oxidizing and the second oxidizing fluids are different.

32. The method of claim 29 wherein the oxidizing fluids are introduced as air/ozone gas stream.

33. The method of claim 29 wherein the first oxidizing fluid is introduced as air/ozone gas stream delivered with hydrogen peroxide, and/or a hydro-peroxide, which is a substantial byproduct of a reaction of a contaminant present in the aquifer or soil formation with the ozone.

34. The method of claim 29 wherein the reducing fluid is selected from the group consisting of hydrogen sulfide, sodium dithionate, sodium thiosulfate, ferrous sulfate, ferrous sulfite, methanol, ethanol, and lactate.

35. The method of claim 29 wherein the second oxidizing fluid is a diluted quantity of the first second oxidizing fluid.

36. The method of claim 33 wherein the hydro-peroxide or hydrogen peroxide is delivered as a surface layer over microbubbles including air/ozone gas stream.

38. The method of claim 33 wherein the hydro-peroxide or hydrogen peroxide is delivered with a first diffuser that is disposed above a second diffuser that delivers the air/ozone gas stream.
